(19) United States
(12) Patent Application Publication
(10) Pub. No.: US 2005/0213163 A1
(43) Pub. Date: Sep. 29, 2005

(54) Image processing device and image processing method

(75) Inventor: Toshiyuki Sotsuka, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/086,090

(22) Filed: Mar. 21, 2005

(30) Foreign Application Priority Data
Mar. 29, 2004 (JP) 2004-094690
Mar. 30, 2004 (JP) 2004-097787

(51) Int. Cl. H04N 1/00

(52) U.S. Cl. 358/400; 358/471

(57) ABSTRACT

An image processing device includes a memory, a buffer, an executing unit, and a retrieving and outputting unit. The memory accumulates image data of one page. In the memory, a storage area according to a data volume of inverted partial image data to be written is provided continuously to a storage area which accumulates the image data of one page. The buffer accumulates partial image data, which is a part of the image data accumulated in the memory. The executing unit executes an inverting process of the partial image data by writing the partial image data to the buffer and writing the partial image data from the buffer to the memory. The retrieving and outputting unit retrieves and outputs simultaneously from the memory, non-inverted image data and the inverted partial image data.

### BACKGROUND OF THE INVENTION

1. Field of the Invention

The present invention relates to an image processing device which can obtain both a non-rotated output and a rotated output of image data of one page accumulated in a memory. The present invention also relates to an image processing device which can simultaneously obtain rotated outputs according to a plurality of types of rotation patterns of image data of one page accumulated in a memory.

2. Description of Related Art

An image processing device such as a facsimile machine, a digital copying machine, a printer and a Multi Function Peripheral (MFP) having a facsimile function, a copying function and a printer function, which processes an image, has a function for printing image data scanned by the image processing device or image data input from a remote device onto paper by rotating the image data 90 degrees clockwise or counterclockwise. Such a rotation process of the image data is useful, for example, in case of corresponding a length direction of a figure drawn by the image data with a length direction of the paper to facilitate visualization, or in case of continuing a printing process, even when paper set in a prescribed direction runs out, by using another paper set in a direction 90 degrees different from the prescribed direction.

Conventionally, the rotation process of the image data in the image processing device is generally carried out as follows by using a page memory. The image data scanned by the image processing device or the image data of one page input from a remote device is accumulated once in the page memory. Partial image data having the same number of pixels in a column direction and a row direction is retrieved from the accumulated image data. The retrieved partial image data is inverted and the inverted partial image data is written into an original address of the page memory. This series of operations are carried out for the image data of one page and the inverted image data for the rotation process is generated. By retrieving the inverted image data in a desired order, rotated image data is output.

To improve the efficiency of the processing in the image processing device, for one image data of one page, the original image data and rotated image data of the original image data may be transmitted to different hardware components in the image processing device, respectively. As one example, non-rotated original image data may be transmitted to a printer device and rotated image data may be transmitted to a codec, which carries out an encoding process of the image data. In such a case, from an aspect of improving the efficiency of the processing, it is effective to simultaneously obtain the non-rotated original image data and the rotated image data and to simultaneously transmit each of the image data to a corresponding hardware component, respectively.

In such a conventional image processing device, the partial image data retrieved from the page memory is inverted and the inverted partial image data is written into the original address of the page memory. As a result, the original image data is rewritten. Thus, there is a drawback that the non-rotated original image data and the rotated image data cannot be output simultaneously (first drawback).

To improve the efficiency of the processing in the image processing device, for one image data of one page, rotated image data of the image data rotated according to a first rotation pattern (for example, a clockwise 90 degree rotation) and rotated image data of the image data rotated according to a second rotation pattern (for example, a counterclockwise 90 degree rotation) may be transmitted to different hardware components in the image processing device, respectively. As one example, image data rotated 90 degrees clockwise may be transmitted to a printer device and image data rotated 90 degrees counterclockwise may be transmitted to a codec, which carries out an encoding process of the image data. In such a case, from an aspect of improving the efficiency of the processing, it is effective to simultaneously obtain the image data rotated according to the two types of rotation patterns and to simultaneously transmit each of the image data to a corresponding hardware component, respectively.

In such a conventional image processing device, the partial image data retrieved from the page memory is inverted and the inverted partial image data is written into the original address of the page memory. Therefore, there is a drawback that the image data rotated according to a plurality of types of rotation patterns (for example, the image data rotated 90 degrees clockwise and the image data rotated 90 degrees counterclockwise) cannot be output simultaneously (second drawback).

### SUMMARY OF THE INVENTION

The present invention has been made in consideration of the above-described circumstances. A first advantage of the present invention is to provide an image processing device which can simultaneously output non-rotated image data and rotated image data by accumulating inverted partial image data in a storage area that is different from original image data, without rewriting the original image data, and which can efficiently use a storage area of a memory by continuously accumulating the original image data and the inverted partial image data in the storage area of the memory.

A second advantage of the present invention is to provide an image processing device which can simultaneously output a plurality of types of image data having different rotation patterns by accumulating partial image data inverted according to each of a plurality of types of rotation patterns in a storage area that is different from original image data, and which can efficiently use a storage area of a memory by continuously accumulating the original image data and the inverted partial image data in the storage area of the memory.

To accomplish the first advantage of the present invention, according to an aspect of the present invention, an image processing device carries out a processing for outputting image data of one page without inverting the image data and a processing for outputting the image data by inverting the image data. The image processing device includes a memory, a buffer, an executing unit and a retrieving and outputting unit. The memory accumulates image data of one page. In the memory, a storage area according to a data volume of inverted partial image data to be written is provided continuously to a storage area which accumulates the image data of one page. The buffer accumulates partial image data, which is a part of the image data accumulated in the memory. The executing unit executes an inverting process of the partial image data by writing the partial image data to the buffer and writing the partial image data from the buffer to the memory. The retrieving and outputting unit simultaneously retrieves and outputs the non-inverted image data and the inverted partial image data from the memory.

According to the above-described aspect of the present invention, with respect to the image data of one page accumulated in the memory, the image processing device retrieves the partial image data based on a plurality of pixels, which is a part of the image data of one page, and executes an inverting process for switching a column direction and a row direction. The image processing device writes the inverted partial image data into the storage area in the memory that is different from the original image data of one page. Therefore, the original image data of one page is not rewritten. The non-inverted original image data and the inverted partial image data are retrieved from the memory by controlling a retrieving address of each of the image data. Accordingly, the non-rotated original image data and the rotated image data are output simultaneously. In the memory, a minimum storage area for accumulating the inverted partial image data is secured continuously to the storage area which accumulates the non-inverted original image data. As a result, an unnecessary storage area is not required to be secured and the memory can be utilized efficiently.

According to another aspect of the present invention, in the memory of the image processing device, a storage area which accumulates non-inverted image data of a next page is provided continuously to the storage area in which the inverted partial image data is written.

According to the above-described aspect of the present invention, in the memory of image processing device, the storage area which accumulates the non-inverted image data of a next one page is secured continuously to the storage area which accumulates the inverted partial image data of a previous page. Therefore, there is no waste in a use of the storage area and the memory can be utilized efficiently.

According to another aspect of the present invention, the memory of the image processing device includes two storage areas for writing the inverted partial image data. A writing operation of the partial image data and a retrieving operation of the partial image data in the two storage areas are carried out alternately in the two storage areas.

According to the above-described aspect of the present invention, two storage areas are set in the memory for writing the inverted partial image data, and the writing operation of the partial image data and the retrieving operation of the partial image data in the two storage areas are carried out alternately. Therefore, the inverted partial image data (the rotated image data) is output efficiently by using a small storage area.

According to the above-described aspect of the present invention, the partial image data is retrieved from the image data of one page accumulated in the memory and an inverting process is executed on the retrieved partial image data. The inverted partial image data is written into the storage area that is different from the storage area which accumulates the image data of one page, not in the original address of the memory. Thus, the original image data is not rewritten. As a result, the non-rotated original image data and the rotated image data can be output simultaneously. Moreover, the area for writing the inverted partial image data is provided continuously to the accumulation area of the original image data. Therefore, the storage area of the memory can be used without waste.

The accumulation area of the non-inverted image data of a next page is provided continuously to the area for writing the inverted partial image data. Therefore, the storage area of the memory can be used without waste.

The writing operation and the retrieving operation of the partial image data are carried out alternately by using two storage areas. Therefore, the rotated image data can be output efficiently by using a small storage area.

To accomplish the second advantage of the present invention, according to another aspect of the present invention, an image processing device carries out a processing for inverting image data of one page according to each of a plurality of types of inverting patterns and outputting the inverted image data. The image processing device includes a memory, a buffer, an executing unit and a retrieving and outputting unit. The memory accumulates image data of one page. In the memory, a storage area according to a data volume of inverted partial image data to be written is provided continuously to a storage area which accumulates the image data of one page. The buffer accumulates partial image data, which is a part of the image data accumulated in the memory. The executing unit executes an inverting process of the partial image data according to each of the plurality of types of the inverting patterns by writing the partial image data to the buffer and writing the partial image data from the buffer to the memory. The retrieving and outputting unit simultaneously retrieves and outputs the inverted partial image data inverted according to each of the plurality of types of the inverting patterns from the memory.

According to the above-described aspect of the present invention, with respect to the image data of one page accumulated in the memory, the image processing device retrieves the partial image data based on a plurality of pixels, which is a part of the image data of one page, and executes an inverting process for switching a column direction and a row direction according to each of a plurality of types of rotation patterns. The image processing device writes the inverted partial image data corresponding to each of the rotation patterns into the storage area in the memory that is different from the original image data of one page. Therefore, the original image data of one page is not rewritten. A plurality of types of the inverted partial image data are retrieved by controlling a retrieving address of each of the partial image data. Accordingly, a plurality of types of image data having different rotation patterns are output simultaneously. In the memory, a minimum storage area for accumulating the inverted partial image data is secured continuously to the storage area which accumulates the non-inverted original image data. As a result, an unnecessary storage area is not required to be secured and the memory can be utilized efficiently.

According to another aspect of the present invention, in the memory of the image processing device, a storage area which accumulates non-inverted image data of a next page is provided continuously to the storage area in which the inverted partial image data is written.

According to the above-described aspect of the present invention, in the memory of the image processing device, the storage area which accumulates the non-inverted image data of a next one page is secured continuously to the storage area which accumulates the inverted partial image data of a previous page. Therefore, there is no waste in the use of the storage area and the memory can be utilized efficiently.

According to another aspect of the present invention, for each inverting pattern, the memory of the image processing device includes two storage areas for writing the inverted partial image data inverted according to each of the plurality of types of the inverting patterns. A writing operation of the partial image data and a retrieving operation of the partial image data in the two storage areas for each inverting pattern are carried out alternately in each of the two storage areas.

According to the above-described aspect of the present invention, for each of the plurality of types of the rotation patterns, two storage areas are set in the memory for writing the inverted partial image data, and the writing operation of the partial image data and the retrieving operation of the partial image data in the two storage areas for each of the rotation patterns are carried out alternately. Therefore, the inverted partial image data (the rotated image data) is output efficiently by using a small storage area.

According to the above-described aspect of the present invention, the partial image data is retrieved from the image data of one page accumulated in the memory and an inverting process is executed on the retrieved partial image data according to each of the plurality of types of the rotation patterns. The inverted partial image data is written into a storage area that is different from the storage area which accumulates the image data of one page, not into the original address of the memory. As a result, a plurality of types of image data having different rotation patterns can be output simultaneously. Moreover, the area for writing the inverted partial image data is provided continuously to the accumulation area of the original image data. Therefore, the storage area of the memory can be used without waste.

The accumulation area of the non-inverted image data of a next page is provided continuously to the area for writing the inverted partial image data. Therefore, the storage area of the memory can be used without waste.

The writing operation and the retrieving operation of the partial image data are carried out alternately by using two storage areas. Therefore, the rotated image data can be output efficiently by using a small storage area.

### BRIEF DESCRIPTION OF THE SEVERAL VIEWS OF THE DRAWINGS

FIG. 1 is a block diagram showing a configuration of an image processing device (a facsimile MFP) according to an embodiment of the present invention.

FIG. 2 shows a configuration of a page memory.

FIG. 3 shows an accumulated state of original image data in an original buffer area.

FIG. 4 shows an accumulated state of inverted partial image data in a first inversion buffer area and a second inversion buffer area.

FIG. 5 shows inverted image data of one page for a clockwise 90 degree rotation process.

FIG. 6 is a flowchart showing an example of an operation procedure of a generation and output process of inverted image data in a facsimile MFP.

FIG. 7 shows a configuration of a page memory.

FIG. 8 shows an accumulated state of first inverted partial image data in a first inversion buffer area and a second inversion buffer area.

FIG. 9 shows an accumulated state of second inverted partial image data in a third inversion buffer area and a fourth inversion buffer area.

FIG. 10 shows inverted image data of one page for a clockwise 90 degree rotation process.

FIG. 11 shows inverted image data of one page for a counterclockwise 90 degree rotation process.

### DETAILED DESCRIPTION OF THE INVENTION

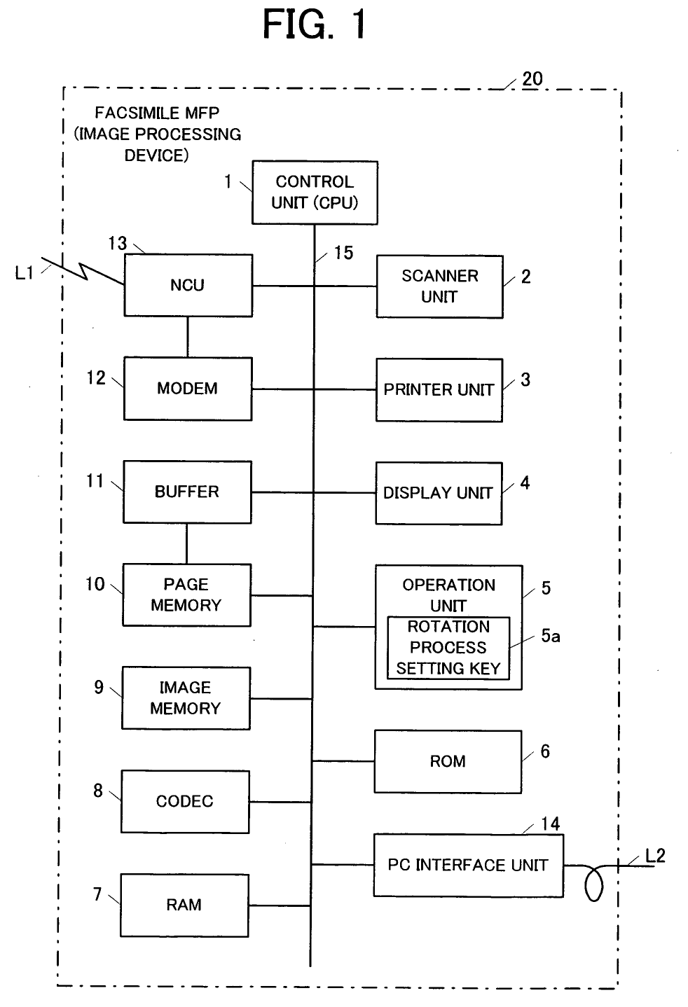

With reference to the drawings, embodiments of the present invention will be described. First, referring to FIG. 1 through FIG. 6, a first embodiment of the present invention will be described. FIG. 1 is a block diagram showing a configuration of a facsimile MFP 20 as an image processing device according to an embodiment of the present invention.

The facsimile MFP 20 includes a control unit 1, a scanner unit 2, a printer unit 3, a display unit 4, an operation unit 5, a Read Only Memory (ROM) 6, a Random Access Memory (RAM) 7, a codec 8, an image memory 9, a page memory 10, a buffer 11, a modem 12, a Network Control Unit (NCU) 13 and a Personal Computer (PC) interface unit 14 or the like. The facsimile MFP 20 includes a scanner function, a printer function and a transmission function. The scanner function is a function for scanning an original document by the scanner unit 2 and obtaining image data. The printer function is a function for printing an image by the printer unit 3 according to scanned image data, image data received by facsimile communication or image data transmitted from a remote PC. The transmission function is a function for carrying out facsimile transmission of the scanned image data or the received image data.

The control unit 1 is specifically formed with a Central Processing Unit (CPU). The control unit 1 is connected to each of the above-mentioned hardware components of the facsimile MFP 20 via a bus 15. The control unit 1 controls each of the hardware components. The control unit 1 executes various software functions in accordance with a control program stored in the ROM 6. The scanner unit 2 scans an original document by using a Charge Coupled Device (CCD) image sensor or the like and outputs the scanned image data.

The printer unit 3 is an electrophotographic printer device and prints out an image onto paper according to image data of an original document scanned by the scanner unit 2, image data received by facsimile communication, image data transmitted from a remote PC, or the like. The display unit 4 is a display device such as a Liquid Crystal Display (LCD) and a Cathode Ray Tube (CRT) display. The display unit 4 displays an operational state of the facsimile MFP 20 and a screen for urging a user to carry out an operation and an input. The display unit 4 also displays image data of an original document scanned to be transmitted, image data transmitted from another facsimile machine or a PC, or the like.

The operation unit 5 includes a character key, a ten-key numeric pad, a speed-dial key, a one-touch dial key and various function keys or the like necessary for operating the facsimile MFP 20. The operation unit 5 includes a rotation process setting key 5a as a function key. The rotation process setting key 5a is a key for setting whether or not to carry out a rotation process of image data by using the page memory 10 and the buffer 11. The rotation process setting key 5a is also a key for setting a type of the rotation. As a type of the rotation, for example, a clockwise 90 degree rotation or a counterclockwise 90 degree rotation can be set. Further, by providing the display unit 4 as a touch panel, a part or all of the various keys of the operation unit 5 can be substituted.

The ROM 6 previously stores various software programs necessary for an operation of the facsimile MFP 20. The RAM 7 is formed with a Static RAM (SRAM) or a flash memory or the like. The RAM 7 stores temporary data that is generated when software is executed. The codec 8 compresses and encodes image data and decodes compressed and encoded image data. The image memory 9 accumulates image data, which is scanned from an original document and encoded, and image data, which is received from another facsimile machine or a PC and encoded, or the like.

The page memory 10 is formed with a Synchronous Dynamic RAM (SDRAM) or the like. The page memory 10 accumulates image data of one page scanned by the scanner unit 2, image data of one page transmitted from another facsimile machine or a PC, or the like. The page memory 10 accumulates inverted image data of original image data in a buffer area that is different from the original image data.

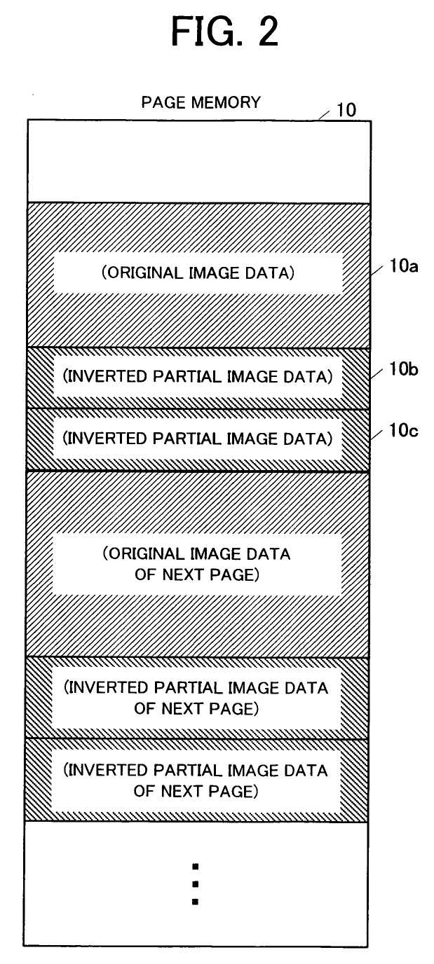

FIG. 2 shows a configuration of the page memory 10. The page memory 10 includes an original buffer area 10a, a first inversion buffer area 10b and a second inversion buffer area 10c. The original buffer area 10a is an area for accumulating non-inverted original image data of one page. The first inversion buffer area 10b and the second inversion buffer area 10c are areas for accumulating inverted partial image data which is formed by inverting a part of the original image data of one page. The first inversion buffer area 10b and the second inversion buffer area 10c are provided continuously to the original buffer area 10a. The size of the first inversion buffer area 10b and the second inversion buffer area 10c is the minimum size necessary for rotating target original image data and is calculated according to the original image data. Therefore, an address of the first inversion buffer area 10b and the second inversion buffer area 10c can be changed.

Next, a description will be made of a specific calculation method for calculating a necessary storage capacity of the first inversion buffer area 10b and the second inversion buffer area 10c. Suppose that image data is binary data, a unit of inversion is n×n pixels and the accumulated image data of one page is y lines. Then, a necessary storage capacity M for each of the first inversion buffer area 10b and the second inversion buffer area 10c becomes as follows, provided that a and b are natural numbers (0<b<n).
(1) when y=a×n, M=a×n² (bits) (Equation 1)
(2) when y=a×n+b, M=(a+1)×n² (bits) (Equation 2)

An original buffer area 10a for accumulating image data of a next page is provided continuously to the first inversion buffer area 10b and the second inversion buffer area 10c. As described above, since the original buffer area 10a and the minimum first inversion buffer area 10b and the minimum second inversion buffer area 10c are provided continuously within the page memory 10, there is no waste at all in the use of the storage area of the page memory 10.

The original image data or the inverted partial image data accumulated in the page memory 10 is retrieved to the printer unit 3 and a normal image or a rotated image according to the image data is printed onto a sheet. The original image data or the inverted partial image data is output to the codec 8 to be compressed and encoded. To improve efficiency, the original image data and the inverted partial image data based on the same page may be output simultaneously to the printer 3 and the codec 8, respectively.

The buffer 11 has n² flip-flops configured as a matrix of n×n (n; natural number). Each flip-flop retains binary data of each pixel. Between the page memory 10 and the buffer 11, data can be written and retrieved with data of n² pixels of n×n of the page memory 10 as one unit. By controlling the writing and the retrieving of the data as needed, the inverted image data in the rotation process of the image data is generated.

The modem 12 is connected to the bus 15 and is formed with a faxmodem which can carry out facsimile communication. The modem 12 is also connected directly to the NCU 13, which is also connected to the bus 15. The NCU 13 is a hardware component which carries out a closing and a releasing operation of a line L1 for a Public Switched Telephone Network (PSTN). The NCU 13 establishes a connection between the modem 12 and the PSTN as needed. The facsimile MFP 20 is connected to another facsimile machine through the PSTN and can carry out general facsimile communication. The PC interface unit 14 is connected to a remote PC via a communication line L2 such as a Local Area Network (LAN) and exchanges data with the PC. Accordingly, various image data created and edited by the remote PC can be transmitted to the facsimile MFP 20 (the PC interface unit 14) via the communication line L2. The facsimile MFP 20 can print out an image onto paper by the printer unit 3 according to the image data transmitted from the remote PC.

Next, a description will be made of an example of an output process of the image data in the facsimile MFP 20, in case of simultaneously outputting non-rotated original image data to the codec 8 and inverted image data in a clockwise 90 degree rotation to the printer unit 3. In this example, n, which is a unit of inversion, is 8.

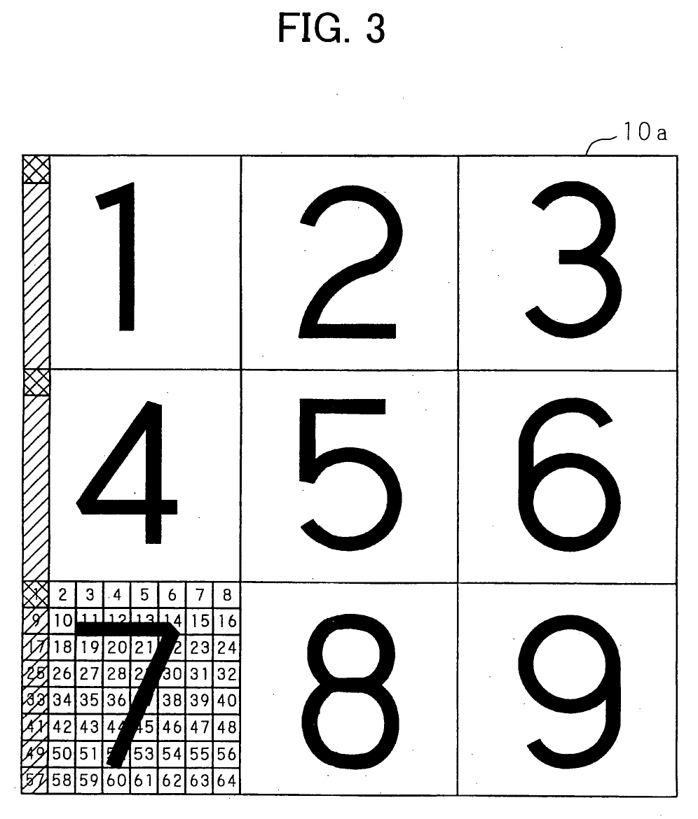

First, the image data of one page is accumulated in the original buffer area 10a of the page memory 10. FIG. 3 shows an accumulated state of original image data in the original buffer area 10a. In this example, the number of lines is y=24. The image data under this state is directly output to the codec 8. Meanwhile, inverted image data, which is inverted in a following manner, is output to the printer unit 3.

A storage capacity necessary as the first inversion buffer area 10b and the second inversion buffer area 10c is calculated. Since a unit of inversion is n=8 and the number of lines is y=24, a=3. From the above-described (Equation 1), the necessary storage capacity M for each of the first inversion buffer area 10b and the second inversion buffer area 10c becomes M=3×8²=192 (bits).

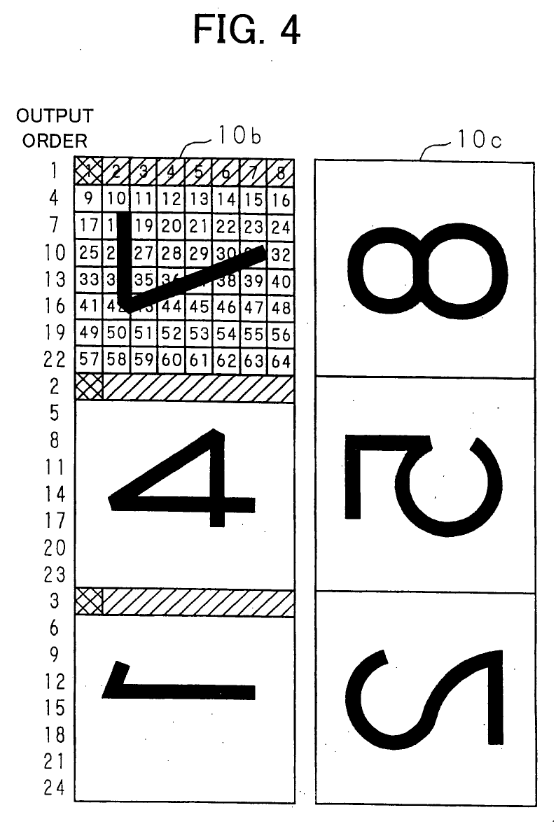

The data of one unit (block) of the image data accumulated in the original buffer area 10a of the page memory 10 is retrieved from the page memory 10. The retrieved data is written into the buffer 11 in a column direction of the data. One block is 64 pixels of an 8×8 square shape. The retrieving and writing process for retrieving the data from the page memory 10 and writing the retrieved data into the buffer 11 is carried out in units of block (a unit of 8×8) . After the writing operation has been completed, the data written in the buffer 11 is retrieved from a row direction of the data. The retrieved data is written into the first inversion buffer area 10b or the second inversion buffer area 10c of the page memory 10. The inverted partial image data as intermediate data for a clockwise 90 degree rotation process is generated as described above. FIG. 4 shows an accumulated state of the inverted partial image data in the first inversion buffer area 10b and the second inversion buffer area 10c. The calculated minimum first inversion buffer area 10b and the second inversion buffer area 10c are provided continuously to the original buffer area 10a. Therefore, the storage area of the page memory 10a can be used efficiently without any waste.

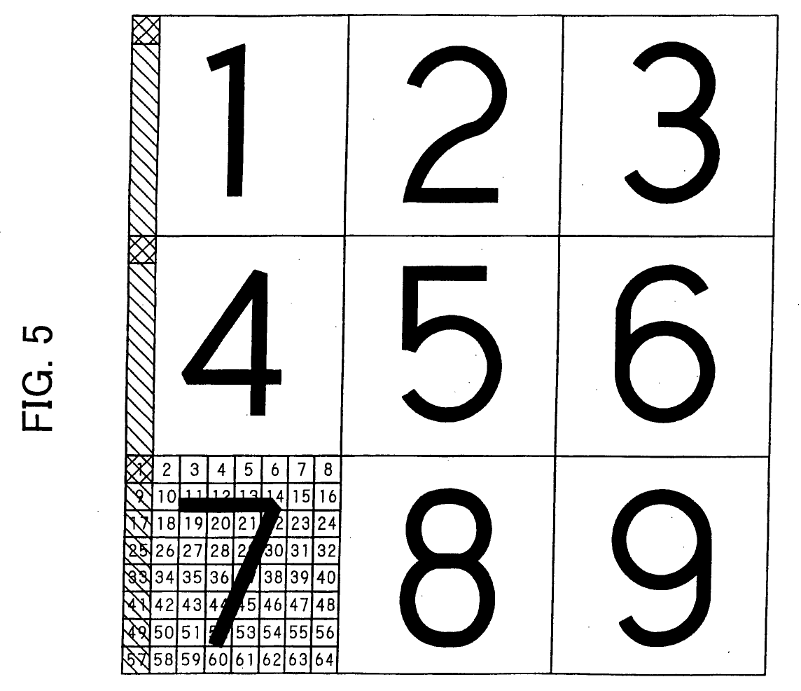

The inverted partial image data accumulated in the first inversion buffer area 10b and the second inversion buffer area 10c are retrieved and output to the printer unit 3. In this case, at a point of time when one of the inversion buffer areas becomes full with data, another inversion buffer area is selected and the same generation process of inverted partial image data is continued. In addition, the inverted partial image data is retrieved from one of the inversion buffer areas. As described above, in the first inversion buffer area 10b and the second inversion buffer area 10c, the writing operation of the inverted partial image data and the retrieving operation of the inverted partial image data are carried out alternately. By repeating such processes until an output of one page is completed, the inverted image data of one page as shown in FIG. 5 can be output to the printer unit 3. While the inverted image data is being output to the printer unit 3, the non-inverted original image data accumulated in the original buffer area 10a is simultaneously retrieved and output to the codec 8.

As described above, the original image data and the inverted image data can be output simultaneously to different hardware components, respectively.

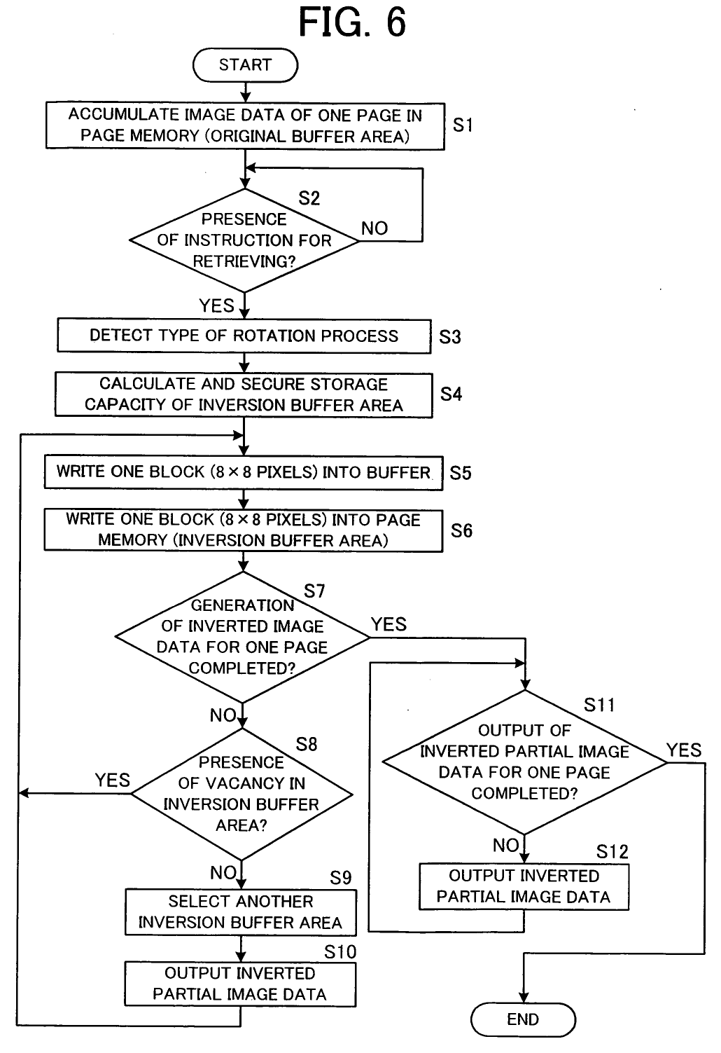

FIG. 6 is a flowchart showing an example of an operation procedure of a generation and output process of the inverted image data.

The image data scanned by the scanner unit 2 or the image data transmitted from another facsimile machine or a PC for one page is accumulated in the original buffer area 10a of the page memory 10 (step S1). The control unit 1 determines the presence or the absence of an instruction for retrieving (step S2). In case of the absence of the instruction for retrieving (step S2: NO), the instruction for retrieving continues to be monitored. In case of the presence of the instruction for retrieving (step S2: YES) , the control unit 1 detects a type of a set rotation process (a clockwise 90 degree rotation or a counterclockwise 90 degree rotation) (step S3). In addition, a storage capacity necessary as the first inversion buffer area 10b and the second inversion buffer area 10c is calculated and the storage area of the calculated capacity is secured in the page memory 10 (step S4).

The data of one block (8×8) of the image data accumulated in the original buffer area 10a is retrieved from the original buffer area 10a and written into the buffer 11 (step S5). In this case, the data is written in the column direction of the buffer 11. After the writing operation has been completed, the data written in the buffer 11 is retrieved from the row direction of the data. The retrieved data is written into one of the inversion buffer areas (for example, the first inversion buffer area 10b) of the page memory 10 (step S6).

The control unit 1 determines whether or not the inverting process (the writing and retrieving operation to the buffer 11) for the image data of one page has been completed (step S7). In case the inverting process has not been completed (step S7: NO), the control unit 1 determines the presence or the absence of a vacancy in one of the inversion buffer areas (step S8). In case of the presence of a vacancy (step S8: YES), the operation returns to step S5 and the generation process of the inverted partial image data for one of the inversion buffer areas is repeated.

In case of the absence of a vacancy in one of the inversion buffer areas (step S8: NO), the control unit 1 selects another inversion buffer area (for example, the second inversion buffer area 10c) (step S9). The control unit 1 starts to retrieve and output the inverted partial image data accumulated in one of the inversion buffer areas (step S10). Then, the operation returns to step S5 and the generation process of the inverted partial image data is carried out for the other inversion buffer area. As described above, according to an embodiment of the present invention, while the retrieving operation of the inverted partial image data is being carried out in one of the inversion buffer areas, the writing operation of the inverted partial image data is carried out in the other inversion buffer area. While the writing operation of the inverted partial image data is being carried out in one of the inversion buffer areas, the retrieving operation of the inverted partial image data is carried out in the other inversion buffer area. That is, the writing operation of the inverted partial image data and the retrieving operation of the inverted partial image data are carried out alternately in the first inversion buffer area 10b and the second inversion buffer area 10c. The operation efficiency is extremely high even when using a small storage area.

In case the inverting process for the image data of one page has been completed (step S7: YES), the control unit 1 determines whether or not the output of the inverted partial image data for one page has been completed (step S11). In case the output process has not been completed (step S11: NO), the output process is continued (step S12) and the operation returns to step S11. In case the inverted partial image data of one page has been output (step S11: YES), the operation ends.

According to an embodiment of the present invention, by the operation shown in the flowchart of FIG. 6, while the inverted image data is being output to one of the hardware components (for example, the printer unit 3), the non-rotated original image data is output simultaneously to another hardware component (for example, the codec 8). As a result, the output of the non-rotated image data and the output of the rotated image data can be carried out simultaneously.

In the above-described example, the image data is binary data. However, the image data can be multi-level data. In case the image data is multi-level data of t bits, the storage capacity M necessary for each of the first inversion buffer area 10b and the second inversion buffer area 10c becomes as follows. n, y, a and b represent the same element as the above-described (Equation 1) and (Equation 2).
(3) when y=a×n, M=a×n²×t (bits) (Equation 3)
(4) when y=a×n+b, M=(a+1)×n²×t (bits) (Equation 4)

In the above-described first embodiment of the present invention, an example of the clockwise 90 degree rotation process of the image data has been described. The present invention can also be applied to a process for rotating the image data 90 degrees counterclockwise. Moreover, in the above-described first embodiment, the inverted image data is generated with 8×8 pixels as one unit. However, this is just one example and the number of pixels of one unit may be any value. Furthermore, the first embodiment has been described with the facsimile MFP as an example. However, the present invention can also be applied to all devices which rotate and output the obtained image data, such as a facsimile machine, a digital copying machine and a printer.

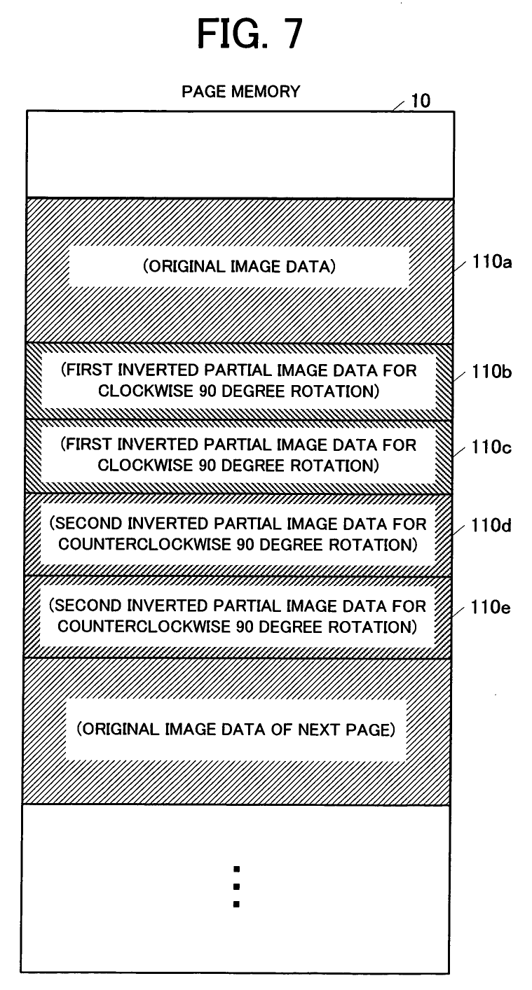

Next, referring to FIG. 7 through FIG. 11, a second embodiment of the present invention will be described. FIG. 1, FIG. 3 and FIG. 6 referred in the description of the first embodiment can also be used in the description of the second embodiment. Further, in the description of the second embodiment, a description that is common with the description of the first embodiment will be omitted appropriately. In addition, the same reference numeral is applied to a structure of the second embodiment that is the same as the first embodiment.

The page memory 10 is formed with a SDRAM or the like and accumulates image data of one page scanned by the scanner unit 2 and image data of one page transmitted from another facsimile machine or a PC. The page memory 10 accumulates in a buffer area that is different from original image data, inverted image data which is formed by inverting the original image data according to each of a plurality of types of rotation patterns.

FIG. 7 shows a configuration of the page memory 10. The page memory 10 includes an original buffer area 110a, a first inversion buffer area 110b, a second inversion buffer area 110c, a third inversion buffer area 110d and a fourth inversion buffer area 110e. The original buffer area 110a is an area for accumulating non-rotated original image data of one page. The first inversion buffer area 110b and the second inversion buffer area 110c are areas for accumulating first inverted partial image data which is formed by inverting a part of the original image data of one page according to a first rotation pattern (clockwise 90 degrees rotation). The third inversion buffer area 110d and the fourth inversion buffer area 110e are areas for accumulating second inverted partial image data which is formed by inverting a part of the original image data of one page according to a second rotation pattern (counterclockwise 90 degree rotation). The first inversion buffer area 110b, the second inversion buffer area 110c, the third inversion buffer area 110d and the fourth inversion buffer area 110e are provided continuously to the original buffer area 110a. The size of the first, the second, the third and the fourth inversion buffer areas 110b, 110c, 110d and 110e is the minimum size necessary for rotating the target original image data and is calculated according to the original image data. Therefore, an address of the inversion buffer areas 110b to 110e can be changed.

Next, a description will be made of a specific calculation method for calculating a necessary storage capacity of the first, the second, the third and the fourth inversion buffer areas 110b, 110c, 110d and 110e, respectively. Suppose that the image data is binary data, a unit of inversion is n×n pixels and the accumulated image data of one page is y lines. Then, the necessary storage capacity M for each of the first, the second, the third and the fourth inversion buffer areas 110b, 110c, 110d and 110e, respectively, becomes as follows, provided that a and b are natural numbers (0<b<n).
(1) when y=a×n, M=a×n² (bits) Equation 1)
(2) when y=a×n+b, M=(a+1)×n² (bits) (Equation 2)

An original buffer area 110a for accumulating image data of a next page is provided continuously to the first, the second, the third and the fourth inversion buffer areas 110b, 110c, 110d and 110e, respectively. As described above, since the original buffer area 110a and the first, the second, the third and the fourth inversion buffer areas 110b, 110c, 110d and 110e, respectively, are provided continuously within the page memory 10, there is no waste at all in a use of the storage area of the page memory 10.

The original image data or a plurality of types of inverted partial image data accumulated in the page memory 10 is retrieved to the printer unit 3, and a normal image or a rotated image according to the image data is printed onto a sheet. The original image data or the plurality of types of the inverted partial image data is output to the codec 8 to be compressed and encoded. To improve efficiency, the inverted partial image data based on the same page having different rotation patterns (for example, inverted partial image data according to a clockwise 90 degree rotation and inverted partial image data according to a counterclockwise 90 degree rotation) may be output simultaneously to the printer unit 3 and the codec 8.

The buffer 11 has two pairs of n² flip-flops configured as a matrix of n×n (n; natural number). Each flip-flop retains binary data of each pixel. Between the page memory 10 and the buffer 11, the data can be written and retrieved with data of n² pixels of n×n of the page memory 10 as one unit. By controlling the writing and the retrieving of the data as needed, the inverted image data in the rotation process based on each of the plurality of types of the rotation patterns of the image data is generated.

Next, a description will be made of an example of an output process of image data in the facsimile MFP 20, in case of simultaneously outputting inverted image data in a clockwise 90 degree rotation to the printer unit 3 and inverted image data in a counterclockwise 90 degree rotation to the codec 8. In this example, n, which is a unit of inversion, is 8.

First, the image data of one page is accumulated in the original buffer area 110a of the page memory 10. FIG. 3 shows an accumulated state of original image data in the original buffer area 110a. In this example, a number of lines is y=24. The inverted image data, which is inverted in a following manner, is output to the printer unit 3 and the codec 8.

A storage capacity necessary as the first, the second, the third and the fourth inversion buffer areas 110b, 110c, 110d and 110e, respectively, is calculated. Since a unit of inversion is n=8 and a number of lines is y=24, a=3. From the above-described (Equation 1), the necessary storage capacity M for each of the inversion buffer areas 110b, 110c, 110d and 110e becomes M=3×8²=192 (bits).

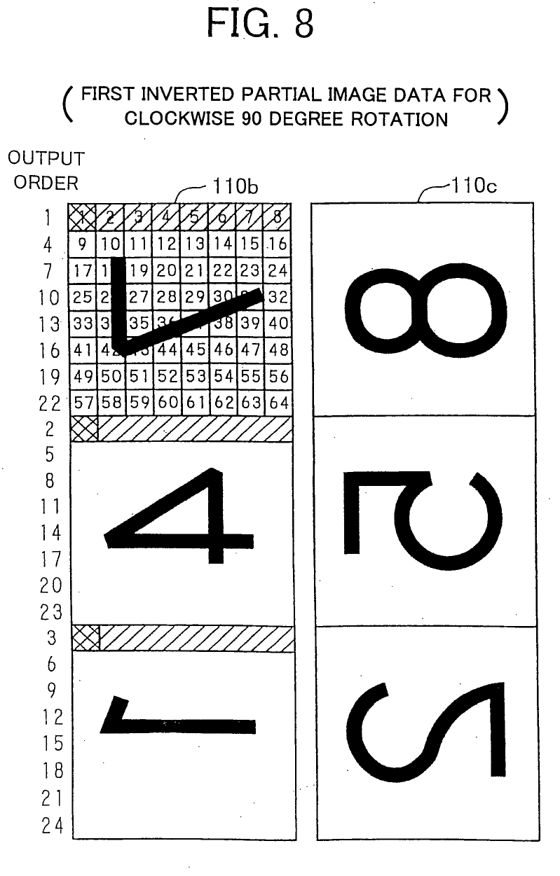

A description will be made of a method for generating first inverted partial image data as intermediate data for a clockwise 90 degree rotation process. First, data of one block of the image data accumulated in the original buffer area 110a of the page memory 10 is retrieved from the page memory 10. The retrieved data is written into the buffer 11 in a column direction of the data. One block is 64 pixels of an 8×8 square shape. The retrieving and writing process for retrieving the data from the page memory 10 and writing the retrieved data into the buffer 11 is carried out in units of blocks (a unit of 8×8). After the writing process has been completed, the data written in the buffer 11 is retrieved from a row direction of the data. The retrieved data is written into the first inversion buffer area 110b or the second inversion buffer area 110c of the page memory 10. The first inverted partial image data as intermediate data for the clockwise 90 degree rotation process is generated as described above. FIG. 8 shows an accumulated state of the first inverted partial image data in the first inversion buffer area 110b and the second inversion buffer area 110c. The calculated minimum first inversion buffer area 110b and the second inversion buffer area 110c are provided continuously to the original buffer area 110a. Therefore, the storage area of the page memory 10 can be used efficiently without any waste.

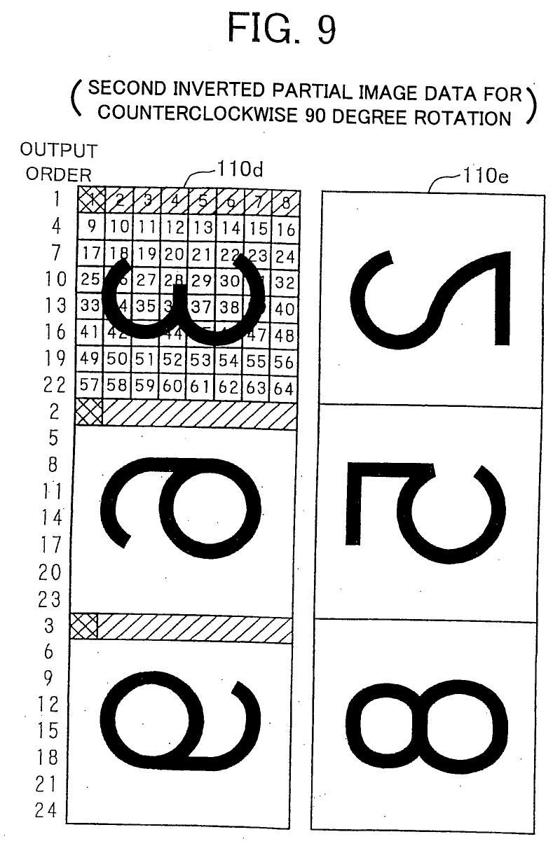

Next, a description will be made of a method for generating second inverted partial image data as intermediate data for a counterclockwise 90 degree rotation process. A processing order of a unit of inversion is differed from the above-described process. The data of one unit (block) of the image data accumulated in the original buffer area 110a of the page memory 10 is retrieved from the page memory 10. The retrieved data is written into the buffer 11 in the column direction of the data. Also in this case, one block is 64 pixels of an 8×8 square shape. The retrieving and writing process for retrieving the data from the page memory 10 and writing the retrieved data into the buffer 11 is carried out in units of blocks (a unit of 8×8). After the writing process has been completed, the data written in the buffer 11 is retrieved from the row direction of the data. The retrieved data is written into the third inversion buffer area 10d or the fourth inversion buffer area 110e of the page memory 10. Accordingly, the second inverted partial image data as intermediate data for the counterclockwise 90 degrees rotation process is generated. FIG. 9 shows an accumulated state of the second inverted partial image data in the third inversion buffer area 110d and the fourth inversion buffer area 110e. The third inversion buffer area 110d and the fourth inversion buffer area 110e are also provided continuously to the first inversion buffer area 110b and the second inversion buffer area 110c and the storage area of the page memory 10 is utilized efficiently.

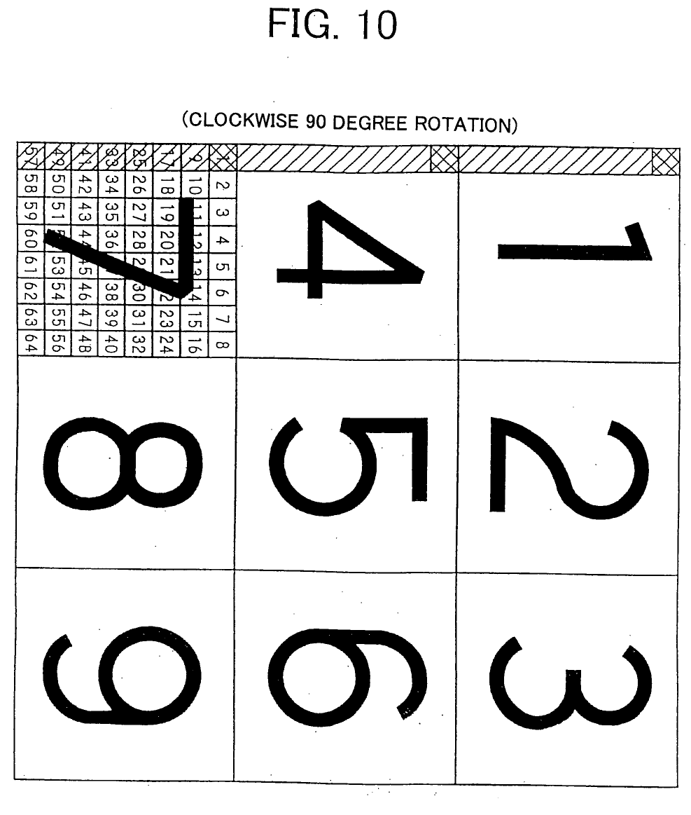

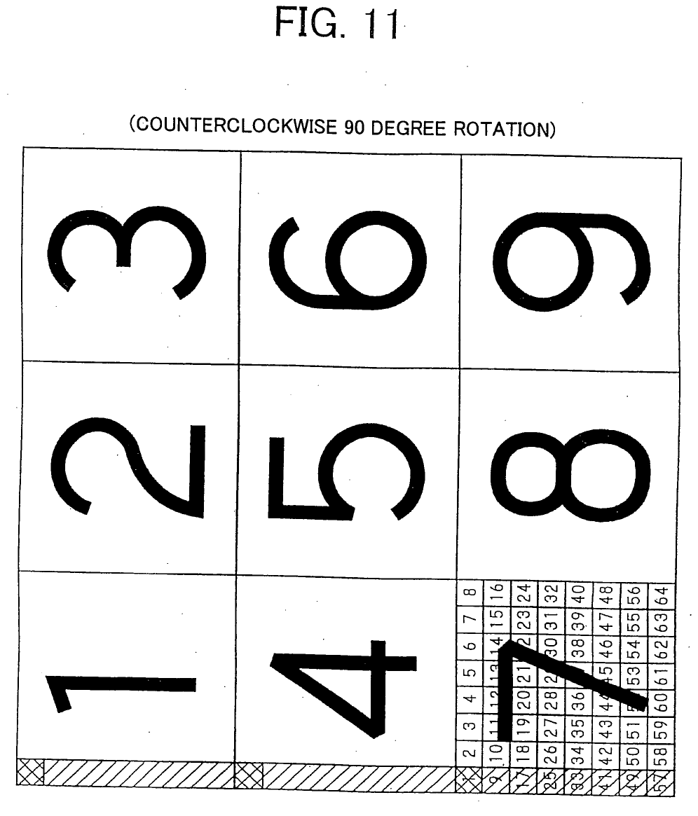

The first inverted partial image data accumulated in the first inversion buffer area 110b and the second inversion buffer area 110c is retrieved and output to the printer unit 3. The second inverted partial image data accumulated in the third inversion buffer area 10d and the fourth inversion buffer area 110e is retrieved and output to the codec 8. In this case, at a point of time when one of the inversion buffer areas becomes full with the data, another inversion buffer area is selected and the same generation process of inverted partial image data is continued. In addition, the inverted partial image data is retrieved from one of the inversion buffer areas. As described above, the writing operation of the inverted partial image data and the retrieving operation of the inverted partial image data are carried out alternately in the first inversion buffer area 110b and the second inversion buffer area 110c, and in the third inversion buffer area 110d and the fourth inversion buffer area 110e. By repeating such processes until an output of one page is completed, the inverted image data of one page according to the clockwise 90 degree rotation as shown in FIG. 10 can be output to the printer unit 3, and the inverted image data of one page according to the counterclockwise 90 degree rotation as shown in FIG. 11 can be output to the codec 8. Further, since the original image data accumulated in the original buffer area 110a is not rewritten, while the inverted image data is being output to the printer unit 3 and the codec 8, the non-inverted original image data can be retrieved and output to another hardware component simultaneously.

As described above, a plurality of types of image data having different rotation patterns can be output simultaneously to different hardware components, respectively.

Next, referring to the flowchart of FIG. 6 used in the description of the first embodiment, a description will be made of an example of an operation procedure of a generation and output process of the inverted image data according to the second embodiment of the present invention.

First, the image data scanned by the scanner unit 2 or the image data transmitted from another facsimile machine or a PC for one page is accumulated in the original buffer area 110a of the page memory 10 (step S1) The control unit 1 determines the presence or the absence of an instruction for retrieving (step S2). In case of the absence of the instruction for retrieving (step S2: NO), the instruction for retrieving continues to be monitored. In case of the presence of the instruction for retrieving (step S2: YES), the control unit 1 detects a type of a set rotation pattern (a clockwise 90 degree rotation or a counterclockwise 90 degree rotation) (step S3). In addition, a storage capacity necessary as the first inversion buffer area 10b, the second inversion buffer area 110c, the third inversion buffer area 110d and the fourth inversion buffer area 110e is calculated, respectively, and the storage area of the calculated capacity is secured in the page memory 10 (step S4). Then, the operations of steps S5 through S12 to be described below are carried out concurrently for the first rotation pattern (the clockwise 90 degree rotation) and the second rotation pattern (the counterclockwise 90 degree rotation).

The data of one block of the image data accumulated in the original buffer area 110a is retrieved from the original buffer area 110a and written into the buffer 11 (step S5). In this case, the data is written in the column direction of the buffer 11. After the writing operation has been completed, the data written in the buffer 11 is retrieved from the row direction of the data. The retrieved data is written into one of the inversion buffer areas (for example, the first inversion buffer area 110b or the third inversion buffer area 110d) (step S6).

The control unit 1 determines whether or not the inverting process (the writing and the retrieving operation to the buffer 11) for the image data of one page has been completed (step S7). In case the inverting process has not been completed (step S7: NO), the control unit 1 determines the presence or the absence of a vacancy in one of the inversion buffer areas (step S8). In case of the presence of a vacancy (step S8: YES), the operation returns to step S5 and the generation process of the inverted partial image data for one of the inversion buffer areas is repeated.

In case of the absence of a vacancy in one of the inversion buffer areas (step S8: NO), the control unit 1 selects another inversion buffer area (for example, the second inversion buffer area 110c or the fourth inversion buffer area 110d) (step S9). The control unit 1 starts to retrieve and output the inverted partial image data accumulated in one of the inversion buffer areas (step S10). Then, the operation returns to step S5 and the generation process of the inverted partial image data is carried out for the other inversion buffer area. As described above, according to an embodiment of the present invention, while the retrieving operation of the inverted partial image data is being carried out in one of the inversion buffer areas (the first inversion buffer area 110b or the second inversion buffer area 110c), the writing operation of the inverted partial image data is carried out in the other inversion buffer area (the second inversion buffer area 110c or the first inversion buffer area 10b). In parallel to these operations, while the writing operation of the inverted partial image data is being carried out in one of the inversion buffer areas (the third inversion buffer area 110d or the fourth inversion buffer area 110e), the retrieving operation of the inverted partial image data is carried out in the other inversion buffer area (the fourth inversion buffer area 110e or the third inversion buffer area 110d) . That is, the writing operation of the inverted partial image data and the retrieving operation of the inverted partial image data are carried out alternately in the first inversion buffer area 110b and the second inversion buffer area 110c, and in the third inversion buffer area 110d and the fourth inversion buffer area 110e. The operation efficiency of the facsimile MFP 20 is extremely high even when using a small storage area.

In case the inverting process for the image data of one page has been completed (step S7: YES), the control unit 1 determines whether or not the output of the inverted partial image data for one page has been completed (step S11). In case the output process has not been completed (step S11: NO), the output process is continued (step S12) and the operation returns to step S11. In case the inverted partial image data of one page for the clockwise 90 degree rotation or the counterclockwise 90 degree rotation has been output (step S11: YES), the operation ends.

According to an embodiment of the present invention, the above-described operations of steps S5 through S12 are carried out concurrently for the first rotation pattern (the clockwise 90 degree rotation) and the second rotation pattern (the counterclockwise 90 degree rotation). Therefore, the inverted image data according to the clockwise 90 degree rotation can be output to the printer unit 3 and the inverted image data according to the counterclockwise 90 degree rotation can be output to the codec 8. As a result, a plurality of types of image data having different rotation patterns can be output simultaneously to different hardware components, respectively.

In the above-described example, the image data is binary data. However, the image data can be multi-level data. In case the image data is multi-level data of t bits, the storage capacity M necessary for each of the first inversion buffer area 10b, the second inversion buffer area 110c, the third inversion buffer area 110d and the fourth inversion buffer area 110d becomes as follows. n, y, a and b represent the same element as the above-described (Equation 1) and (Equation 2).
(3) when y=a×n, M=a×n²×t (bits) (Equation 3)
(4) when y=a×n+b, M=(a+1)×n²×t (bits) (Equation 4)

In the above-described second embodiment of the present invention, an example of two types of rotation patterns (the clockwise 90 degree rotation and the counterclockwise 90 degree rotation) has been described. The present invention can also be applied to a process in which at least three types of rotation patterns are set. For example, a rotation pattern of a 180 degree rotation can be added to the example described in the second embodiment. Moreover, in the above-described second embodiment, the inverted image data is generated with 8×8 pixels as one unit. However, this is just one example and the number of pixels of one unit may be any value. Furthermore, the second embodiment has been described with the facsimile MFP as an example. However, the present invention can also be applied to all devices which rotate and output the obtained image data, such as a facsimile machine, a digital copying machine and a printer.

1. An image processing device, comprising:
a memory which accumulates image data of one page, wherein in the memory, a storage area according to a data volume of inverted partial image data to be written is provided continuously to a storage area which accumulates the image data of one page;
a buffer which accumulates partial image data, which is a part of the image data accumulated in the memory;
means for executing an inverting process of the partial image data by writing the partial image data to the buffer and writing the partial image data from the buffer to the memory; and
means for retrieving and outputting simultaneously from the memory, non-inverted image data and the inverted partial image data.

2. The image processing device according to claim 1, wherein in the memory, a storage area which accumulates non-inverted image data of a next page is provided continuously to the storage area in which the inverted partial image data is written.

3. The image processing device according to claim 1, wherein the memory includes two storage areas for writing the inverted partial image data, and a writing operation of the partial image data and a retrieving operation of the partial image data in the two storage areas are carried out alternately in the two storage areas.

4. The image processing device according to claim 1, wherein the means for retrieving and outputting simultaneously outputs the non-inverted image data to a first output destination and outputs the inverted partial image data to a second output destination.

5. The image processing device according to claim 1, wherein the means for executing carries out a writing operation and a retrieving operation of data between the memory and the buffer with n×n pixels as one unit.

6. An image processing method, comprising:
a first step of accumulating image data of one page in a memory;
a second step of retrieving partial image data, which is a part of the image data, from the memory and accumulating the partial image data in a buffer;
a third step of executing an inverting process of the partial image data by writing the partial image data to the buffer and writing the partial image data from the buffer to the memory; and
a fourth step of simultaneously retrieving and outputting from the memory, non-inverted image data and the inverted partial image data,
wherein at the third step, the partial image data retrieved from the buffer is written continuously to a storage area which accumulates the image data of one page in the memory.

7. The image processing method according to claim 6, further comprising a fifth step of writing non-inverted image data of a next page continuously to a storage area in which the inverted partial image data inverted at the third step is written.

8. The image processing method according to claim 6, wherein the memory includes two storage areas for writing the inverted partial image data, and
at the third step and the fourth step, a writing operation of the inverted partial image data to the memory and a retrieving operation of the inverted partial image data from the memory are carried out alternately in the two storage areas.

9. The image processing method according to claim 6, wherein at the fourth step, at a same time as when the non-inverted image data is output to a first output destination, the inverted partial image data is output to a second output destination.

10. The image processing method according to claim 6, wherein at the third step, a writing operation and a retrieving operation of data between the memory and the buffer are carried out with n×n pixels as one unit.

11. An image processing device, comprising:
a memory which accumulates image data of one page, wherein in the memory, a storage area according to a data volume of inverted partial image data to be written is provided continuously to a storage area which accumulates the image data of one page;
a buffer which accumulates partial image data, which is a part of the image data accumulated in the memory;
means for executing an inverting process of the partial image data according to each of a plurality of types of inverting patterns by writing the partial image data to the buffer and writing the partial image data from the buffer to the memory; and
means for retrieving and outputting simultaneously from the memory, the inverted partial image data inverted according to each of the plurality of types of the inverting patterns.

12. The image processing device according to claim 11, wherein in the memory, a storage area which accumulates non-inverted image data of a next page is provided continuously to the storage area in which the inverted partial image data is written.

13. The image processing device according to claim 11, wherein the memory includes two storage areas for each of the plurality of types of the inverting patterns, each of the storage areas is provided for writing the inverted partial image data inverted according to each of the plurality of types of the inverting patterns; and
a writing operation of the partial image data and a retrieving operation of the partial image data in the two storage areas for each of the inverting patterns are carried out alternately in each of the two storage areas.

14. The image processing device according to claim 11, wherein the means for retrieving and outputting simultaneously outputs the inverted partial image data inverted according to a first inverting pattern to a first output destination and outputs the inverted partial image data inverted according to a second inverting pattern to a second output destination.

15. The image processing device according to claim 11, wherein the means for executing carries out a writing operation and a retrieving operation of data between the memory and the buffer with n×n pixels as one unit.

16. The image processing device according to claim 11, wherein the means for executing concurrently carries out inverting processes according to each of the plurality of types of the inverting patterns.

17. An image processing method, comprising:
a first step of accumulating image data of one page in a memory;
a second step of retrieving partial image data, which is a part of the image data, from the memory and accumulating the partial image data in a buffer;
a third step of executing an inverting process of the partial image data by writing the partial image data to the buffer and writing the partial image data from the buffer to the memory; and
a fourth step of simultaneously retrieving and outputting from the memory, the inverted partial image data inverted according to each of a plurality of types of inverting patterns,
wherein at the third step, the partial image data retrieved from the buffer is written continuously to a storage area which accumulates the image data of one page in the memory.

18. The image processing method according to claim 17, further comprising a fifth step of writing non-inverted image data of a next page continuously to a storage area in which the inverted partial image data inverted at the third step is written.

19. The image processing method according to claim 17, wherein the memory includes two storage areas for each of the plurality of types of the inverting patterns, each of the storage areas is provided for writing the inverted partial image data inverted according to each of the plurality of types of the inverting patterns; and
at the third step and the fourth step, a writing operation of the partial image data and a retrieving operation of the partial image data in the two storage areas for each of the inverting patterns are carried out alternately in each of the two storage areas.

20. The image processing method according to claim 17, wherein at the fourth step, at a same time as when the inverted partial image data inverted according to a first inverting pattern is output to a first output destination, the inverted partial image data inverted according to a second inverting pattern is output to a second output destination.

21. The image processing method according to claim 17, wherein at the third step, a writing operation and a retrieving operation of data between the memory and the buffer are carried out with n×n pixels as one unit.

22. The image processing method according to claim 17, wherein at the third step, inverting processes according to each of the plurality of types of the inverting patterns are carried out concurrently.
